(19) United States
(12) Patent Application Publication
(10) Pub. No.: US 2022/0015336 A1
(43) Pub. Date: Jan. 20, 2022

(54) WARMING BETA FISH FISHBOWL

(71) Applicant: Heather Ann Gregson, Medford, MA (US)

(72) Inventor: Heather Ann Gregson, Medford, MA (US)

(21) Appl. No.: 16/929,098

(22) Filed: Jul. 14, 2020

(51) Int. Cl. A01K 63/06

(52) U.S. Cl. CPC A01K 63/065

(57) ABSTRACT

An article of manufacture for providing an environmentally appropriate fishbowl for maintaining a proper living environment for a Beta Fighting Fish is disclosed. A warming Beta bowl is a non-breakable clear, glass, plastic, or acrylic fishbowl or square with a vented lid. The warming Beta bowl comes with a removable clear non-breakable warming tube that is filled with warm water to give a pet fish a warm area in the bowl without needing an electric heater. The fishbowl vented lid includes a restraining vent opening that is sized and shaped to accept insertion of the warm water tube and hold it in place while in use. Warm water is poured into the warm water tube such that when it is placed in the fishbowl it transfers heat from the warm water to the main water in the fishbowl keeping the water temperature within a desired temperature range.

### TECHNICAL FIELD

This application relates in general to an article of manufacture for providing a pet environment, and more specifically, to an article of manufacture for an environmentally appropriate fishbowl for maintaining a proper living environment for a Beta Fighting Fish.

### BACKGROUND

Many people keep one or more fish in a fishbowl or aquarium as pets. The collection of equipment needed to keep the water in the fishbowl in condition to provide a healthy environment varies from a single fishbowl to an elaborate set up with filters, heaters, lights, and a large stand. For some, the cost of an elaborate set up cannot be easily justified or paid, especially when the pet owners wish to have a Beta Fighting Fish as a pet because these fish typically need to be kept separate from other fish.

Providing an inexpensive yet healthy environment for these small fish arrangements does require that the water that provides a living environment remain clean and have a temperature within a desirable range. Small fishbowls may provide a small number of fish a clean environment if the pet owner periodically changes the water in the fishbowl. For small set ups, this task is not necessarily burdensome.

Providing water in the fishbowl having a water temperature within a desired temperature range may also require action on the part of the pet owner. Water temperature desired for many pet fish is not necessarily different than the ambient air temperature of some household environments. However, assistance to maintain a desirable water temperature may be required, especially for evening hours and localities having harsher local weather patterns. Such assistance would be beneficial if it does not add expense and effort to caring for pet fish in a simple fishbowl.

Therefore, a need exists for an article of manufacture for providing an environmentally appropriate water temperature in a fishbowl for maintaining a proper living environment for pet fish such as a Beta Fighting Fish. Such an article of manufacture would preferably require no more effort or cost than is required to change the water in a fishbowl. The present invention attempts to address these deficiencies in prior art solutions using the principles of the invention as disclosed herein.

### SUMMARY

In accordance with the present invention, the above and other problems are solved by providing an article of manufacture for an environmentally appropriate fishbowl for maintaining a proper living environment for a Beta Fighting Fish according to the principles and example embodiments disclosed herein.

In one embodiment, the present invention is an article of manufacture for providing an environmentally appropriate fishbowl for maintaining a proper living environment for a Beta Fighting Fish. The warming Beta bowl is a non-breakable clear, glass, plastic, or acrylic fishbowl or square with a vented, removable lid. The warming Beta bowl comes with a removable, clear non-breakable warming tube that is filled with warm water to give a pet fish a warm area in the bowl without needing an electric heater. The fishbowl vented lid includes a restraining vent opening that is sized and shaped to accept insertion of the warm water tube and hold it in place while in use. Warm water is poured into the warm water tube such that when it is placed in the fishbowl it transfers heat from the warm water to the main water in the fishbowl keeping the water temperature within a desired temperature range.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for an article of manufacture for an environmentally appropriate fishbowl for maintaining a proper living environment for a Beta Fighting Fish.

FIG. 2 illustrates an example embodiment of an article of manufacture for an environmentally appropriate fishbowl for maintaining a proper living environment for a Beta Fighting Fish with the warming tube 102 removed.

FIG. 3 illustrates an example embodiment of an article of manufacture for an environmentally appropriate fishbowl for maintaining a proper living environment for a Beta Fighting Fish with the warming tube 102 and vented lid 103 removed.

### DETAILED DESCRIPTION

This application relates in general to an article of manufacture for providing a pet environment, and more specifically, to an article of manufacture for an environmentally appropriate fishbowl for maintaining a proper living environment for a Beta Fighting Fish according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “pet owner,” and “user” refer to an entity, e.g. a human, using the warming beta fish fishbowl as a living environment for pet fish associated with the invention. The term user herein refers to one or more users.

The term “invention” or “present invention” refers to the invention being applied for via the patent application with the title “Warming Beta Fish Fishbowl.” Invention may be used interchangeably with fishbowl.

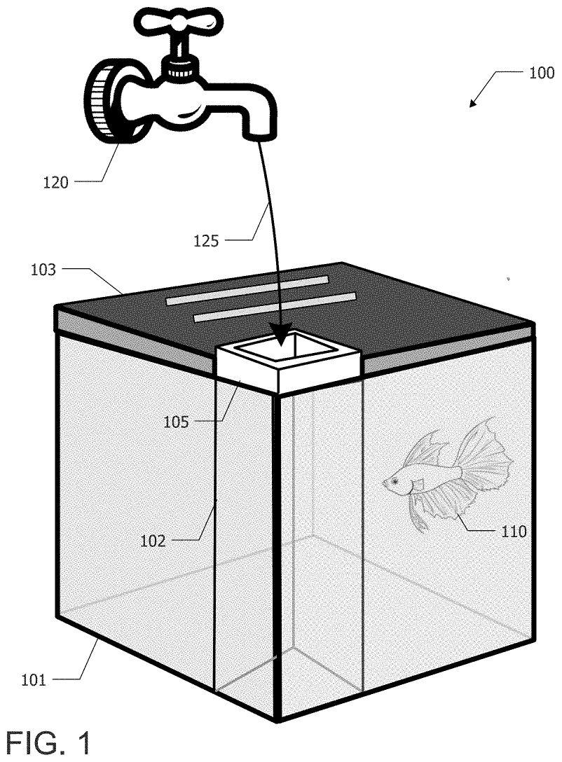

In general, the present disclosure relates to an article of manufacture for providing a pet environment. To better understand the present invention, FIG. 1 illustrates an example embodiment for an article of manufacture for providing an environmentally appropriate fishbowl for maintaining a proper living environment for a Beta Fighting Fish.

The warming Beta bowl 101 is a non-breakable clear, glass, plastic, or acrylic fishbowl or square with a vented removable lid. The warming Beta bowl 101 comes with a removable clear non-breakable warming tube 102 that is filled with warm water 125 to give Beta fish 110 or other tropical fish or fry a warm area in the bowl without needing an electric heater.

The warming Beta bowl 101 is an easy and less expensive way to own Beta fish without needing an expensive tank setup with an electric heater. By using the warm water tube 102, the fish has a warm area of a non-heated bowl/tank which is better for their health and quality of life. The warming Beta bowl 101 is also good as a home for young guppies. It provides a warm safe environment away from predation from adult guppies.

A pet owner may keep a pet fish 110 in the warming Beta bowl 101 without using any additional electronics. In order to keep the water in the fishbowl 101 at a desired temperature for the fish 110, the pet owner may regulate the water temperature on the warming Beta fishbowl 101 by adding warm water 125 from any external source, such as a spigot 120, to the warm water tube 102 while it is located in the warming Beta fishbowl 101. The fishbowl 101 includes a top 103 to cover the fishbowl where the lid 103 has a restraining vent opening 105 that matches the shape of the warm water tube 102 to hold in in place while the tube is in the fishbowl 101.

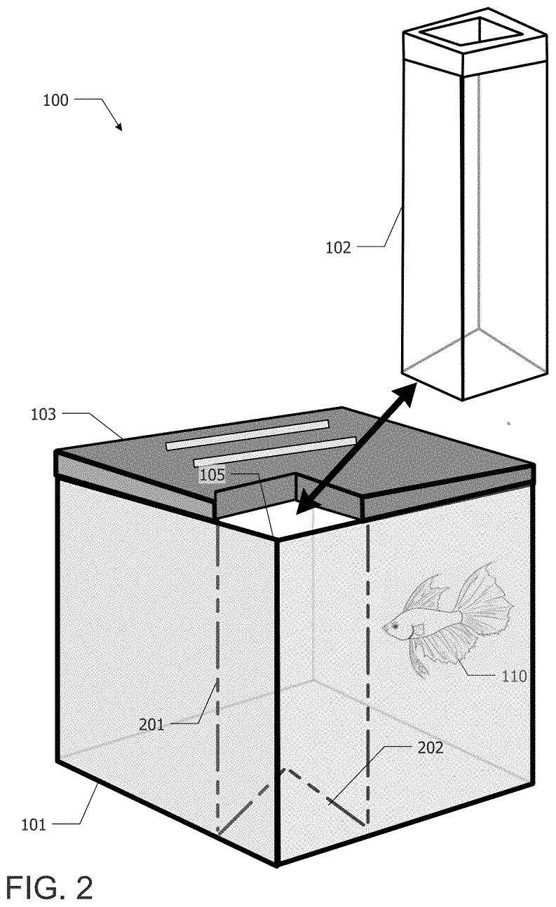

The preferred embodiment as shown in FIGS. 1-2, has the fishbowl 101 configured to be a cube and the warm water tube 102 and its corresponding restraining opening 105 also configured as a square. Other shapes may be possible so long as the warm water tube 102 and its corresponding restraining vent opening 105 are sized to hold the warm water tube 102 in an upright orientation in the fishbowl 101. The use of square shapes for these components makes the manufacture of the components less complicated.

The warm water tube 102 should be capable of holding heated water without breaking, deforming, and leaking. The warm water tube 102 must also be capable of efficiently transferring heat from the warm water within the warm water tube 102 to the main water mass in the fishbowl 101. The warm water tube 102 is made of plastic in a preferred embodiment. The warm water tube 102 typically extends down to the bottom of the fishbowl 101 to rest on the bottom of the inner space of the bowl. The embodiment of FIGS. 1-2 show the warm water tube 102 positioned in a corner of the fishbowl 101 as the sides of the fishbowl assist in keeping the warm water tube in place.

FIG. 2 illustrates an example embodiment of the article of manufacture for providing an environmentally appropriate fishbowl for maintaining a proper living environment for a Beta Fighting Fish having the warming tube 102 removed. The embodiment of FIG. 2 shows the warm water tube 102 after it has been lifted out of the restraining opening 105 of the lid 103 to the fishbowl 101. The pet owner may simply carry the warm water tube 102 to a kitchen for disposal of the water once it has cooled in the tube. The pet owner may then obtain a fresh batch of warm water 125 for refilling the warm water tube 102. The warm water 125 may be added to the warm water tube 102 either before or after the tube has been reinserted into the restraining vent opening 105.

The fishbowl 101 may include warm water tube guides 201-202 along the side and bottom of the fishbowl to aid the insertion and removal of the warm water tube 102 from the restraining opening 105. The warm water tube guides 201-202 may also aid in holding the warm water tube 102 in a desired location while in use.

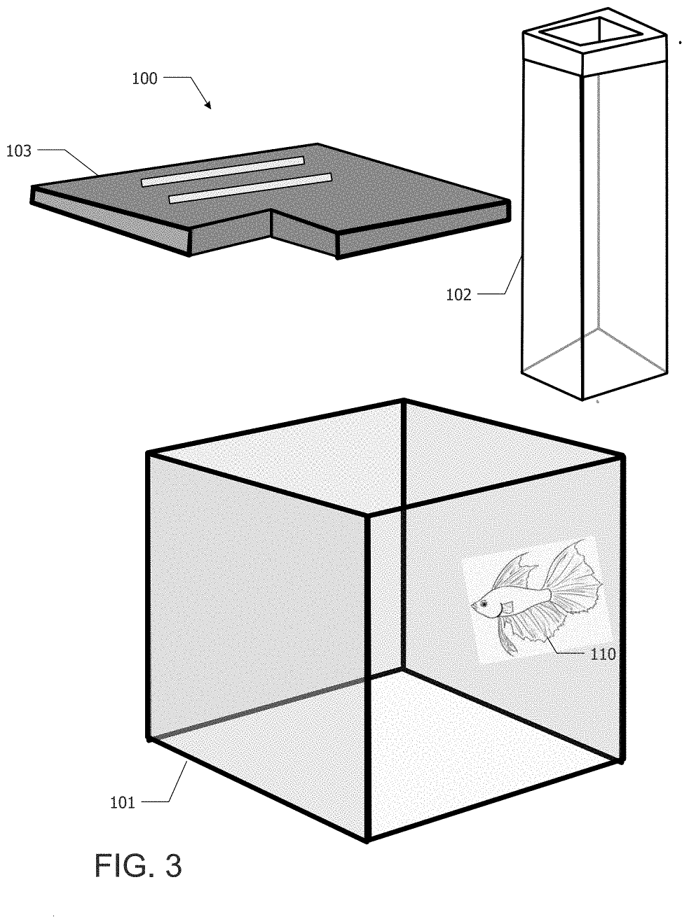

FIG. 3 illustrates an example embodiment of an article of manufacture for an environmentally appropriate fishbowl for maintaining a proper living environment for a Beta Fighting Fish with the warming tube 102 and vented lid 103 removed. The removable, vented lid 103 includes a plurality of vents to allow the exchange of fresh air/ The removable, vented lid 103 lifts out of the fishbowl 101 in a manner similar to the warming tube 102.

A temperature indicator may be included on the inside of the warm water tube 102 to provide the pet owner with a visual indication of whether the warm water 125 in the warm water tube 102 needs replacing. Many different types of temperature indicators may be used.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing an environmentally appropriate fishbowl for maintaining a proper living environment for a fish, the article comprises:
a fishbowl for housing pet fish;
a vented lid having a restraining vent opening; and
a warm water tube for holding warm water that provides a source of heat to water within the fishbowl, the warm water tube has a size and shape enabling the restraining vent opening to hold the warm water tube in a desired upright orientation.

2. The article of manufacture according to claim 1, where the restraining vent opening is larger than the warm water tube permitting the warm water tube to be inserted and removed from the fishbowl through the restraining vent opening.

3. The article of manufacture according to claim 2, where the restraining vent opening and the warm water tube are shaped as a rectangle along a top surface.

4. The article of manufacture according to claim 2, where the restraining vent opening and the warm water tube are shaped as a square along a top surface.

5. The article of manufacture according to claim 2, where the restraining vent opening and the warm water tube are located about a corner of a square fishbowl.

6. The article of manufacture according to claim 1, where the fishbowl comprises one or more warm water tube guides below the restraining vent opening and adjacent to the warm water tube when the warm water tube is within the fishbowl.
